(19) United States
(12) Patent Application Publication
(10) Pub. No.: US 2022/0341215 A1
(43) Pub. Date: Oct. 27, 2022

(54) LOCK DEVICE CAPABLE OF MAGNETIC SENSING, BOLT CALIBRATION METHOD, AND DOOR CALIBRATION METHOD

(71) Applicant: TAIWAN FU HSING INDUSTRIAL CO., LTD., Kaohsiung City (TW)

(72) Inventors: I-Chang Shih, Tainan City (TW); Shih-Min Lu, Kaohsiung City (TW); Pi-Shun Chang, Kaohsiung City (TW)

(73) Assignee: TAIWAN FU HSING INDUSTRIAL CO., LTD., Kaohsiung City (TW)

(21) Appl. No.: 17/688,846

(22) Filed: Mar. 7, 2022

(30) Foreign Application Priority Data
Apr. 27, 2021 (TW) 110115110

(51) Int. Cl. E05B 41/00; E05B 63/00

(52) U.S. Cl. CPC E05B 41/00; E05B 63/0017; E05B 2047/0069

(57) ABSTRACT

A lock device includes a shell, a bolt mechanism, a magnetic member, and a magnetic sensing module. The magnetic member is movable with the bolt mechanism. When the bolt mechanism is moved between a locking position and an unlocking position, the magnetic sensing module senses a magnetic force variation of the magnetic member. The lock device further includes a magnetic force generation member disposed on a wall. When a door located at a door-closed position with the bolt mechanism being moved to the locking position is shaken relative to the wall, the magnetic sensing module senses a magnetic force variation of the magnetic force generation member.

### BACKGROUND OF THE INVENTION

### 1. Field of the Invention

The present invention relates to a lock device, a bolt calibration method, and a door calibration method, and more particular, to a lock device with sensing function, and a bolt calibration method and a door calibration method initializing the lock device to be adapted to a door.

### 2. Description of the Prior Art

In general, the electronic locking system uses two micro-switches and a light blocker signal to determine whether to drive a bolt to rotate or not, which further drives a lock core to perform a bolt locking action. For example, the two micro-switches may be disposed at two positions on a rotation path of the bolt, such as a locking position and an unlocking position. When the bolt is rotated to the micro-switch at the locking position, the micro-switch at the locking position is triggered by the bolt to send a locking position signal. When the bolt is rotated to the micro-switch at the unlocking position, the micro-switch at the unlocking position is triggered by the bolt to send an unlocking position signal. In this way, the electronic locking system can recognize a position of the bolt. In addition, a light blocker is located on a door or a wall, and when the door is opened, the door is relatively moving away from the wall. Therefore, the light blocker changes from a blocked state to a non-blocked state. In this way, the electronic locking system is able to recognize the position of the door.

However, the above mechanism requires two micro-switches and one light blocker to determine the position of the bolt and whether or not the door is closed, which requires more components, and causes more cost and process management problems in manufacture.

### SUMMARY OF THE INVENTION

The present invention provides a lock device with sensing function, and a bolt calibration method and a door calibration method initializing the lock device to be adapted to a door to solve the above mentioned problems.

According to one aspect of the present invention, a lock device adapted to a door is provided. The lock device includes a housing, a bolt mechanism, a magnetic member, and a magnetic sensing module. The housing is disposed on a side of the door. The bolt mechanism is movably disposed on the housing. The bolt mechanism is operable to move between a locking position and an unlocking position. The magnetic member is movable with the bolt mechanism. The magnetic sensing module is disposed inside the housing. The magnetic sensing module senses a magnetic force generated by the magnetic member during a movement of the bolt mechanism between the locking position and the unlocking position.

In one embodiment, the lock device further includes a processing unit for sensing at least one magnetic force variation generated by the magnetic member during at least one movement of the bolt mechanism between the locking position and the unlocking position and further for determining a magnetic interruption threshold interval according to the at least one magnetic force variation when the processing unit is at a bolt calibration mode.

In one embodiment, the magnetic sensing module includes a magnetic sensing processing unit, the processing unit or the magnetic sensing processing unit generates a magnetic event interrupt signal when the magnetic sensing module senses that the magnetic force generated by the magnetic member is within the magnetic interruption threshold interval, and when the magnetic event interrupt signal is generates by the processing unit, the bolt mechanism is located at one of the locking position and the unlocking position.

According to another aspect of the present invention, a bolt calibration method adapted to a lock device is provided. The bolt calibration method includes: entering a bolt calibration mode of the lock device; rotating a bolt mechanism of the lock device at least once between a locking position and an unlocking position after entering the bolt calibration mode of the lock device; and completing a calibration of the lock device.

In one embodiment, rotating the bolt mechanism of the lock device at least once between the locking position and the unlocking position includes: moving the bolt mechanism movable with a magnetic member, disposing a magnetic sensing module inside a shell of the lock device, and the magnetic sensing module sensing at least one magnetic force variation generated by the magnetic member; and determining a magnetic interruption threshold interval according to the at least one magnetic force variation.

In one embodiment, when the magnetic sensing module senses that the magnetic force generated by the magnetic member is within the magnetic interruption threshold interval, the processing unit of the lock device or a magnetic sensing processing unit of the magnetic sensing module generates a magnetic event interrupt signal, and when the magnetic event interrupt signal is generated by the processing unit of the lock device or the magnetic sensing processing unit of the magnetic sensing module, the bolt mechanism is located at one of the locking position and the unlocking position.

According to yet another aspect of the present invention, a lock device adapted to a door is provided. The door is movable toward a door-closed position or away from the door-closed position relative to a wall. The lock device further includes a housing, a bolt mechanism, a magnetic force generating member, and a magnetic sensing module. The housing is disposed on a side of the door. The bolt mechanism is movably disposed on the housing. The magnetic force generating member is disposed on the wall. The magnetic sensing module is disposed inside the housing. When the door is located at the door-closed position and shakes relative to the wall, the magnetic sensing module senses a magnetic force generated by the magnetic force generating member

In one embodiment, the lock device further includes a processing unit for sensing at least one magnetic force variation generated by the magnetic force generating member during a process of at least one shake of the door relative to the wall when the door is located at the door-closed position and the bolt mechanism is located at a locking position and further for determining a door threshold interval according to the at least one magnetic force variation, when the processing unit enters a door calibration mode.

In one embodiment, the magnetic sensing module includes a magnetic sensing processing unit. When the magnetic sensing module senses that the magnetic force generated by the magnetic force generating member is not within the door threshold interval, the processing unit or the magnetic sensing processing unit generates a door unclosed warning signal.

According to yet another aspect of the present invention, a door calibration method adapted to a lock device is provided. The lock device is disposed on a door that moves toward a door-closed position or away from the door-closed position relative to a wall. The lock device is capable of calibrating a position of the door. The door calibration method includes: entering a door calibration mode of the lock device; moving the door to a door-closed position, locking the door, and shaking the door at least once after entering the door calibration mode of the lock device; and completing a calibration of the door.

In one embodiment, moving the door to a door-closed position, locking the door, and shaking the door at least once after entering the door calibration mode of the lock device includes: disposing a magnetic force generating member on the wall, installing a magnetic sensing module inside a shell of the lock device, and the magnetic sensing module sensing at least one magnetic force variation generated by the magnetic force generating member; and determining a door threshold interval according to the at least one magnetic force variation.

In one embodiment, when the magnetic sensing module senses that a magnetic force generated by the magnetic force generating member is not within the door threshold interval, a processing unit of the lock device or the magnetic sensing processing unit generates a door unclosed warning signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic view of a lock device according to an embodiment of the present invention.

FIG. 2 is a schematic view of the lock device at an unlocking position according to an embodiment of the present invention.

FIG. 3 is a schematic exploded view of the lock device according to an embodiment of the present invention.

FIG. 4 is a schematic exploded view of the lock device from another perspective according to an embodiment of the present invention.

FIG. 5 is a schematic view of a knob member and a magnetic member at the unlocking position according to an embodiment of the present invention.

FIG. 6 is a schematic view of the lock device at a locking position according to an embodiment of the present invention.

FIG. 7 is a schematic view of the knob member and the magnetic member at the locking position according to an embodiment of the present invention.

FIG. 8 is a functional block diagram of the lock device according to an embodiment of the present invention.

FIG. 9 is a flowchart of a bolt calibration method according to an embodiment of the present invention.

FIG. 10 is a schematic diagram illustrating a bolt calibration method according to an implementation corresponding to the flowchart in FIG. 9.

FIG. 11 is another schematic diagram illustrating a bolt calibration method according to another implementation corresponding to the flowchart in FIG. 9.

FIG. 12 is a flowchart of a door calibration method according to an embodiment of the present invention.

FIG. 13 is a schematic diagram illustrating a door calibration method according to an implementation corresponding to the flowchart in FIG. 12.

### DETAILED DESCRIPTION

In order to enable those skilled in the art to further understand the present invention, the following is a list of preferred embodiments of the present invention, together with the accompanying drawings to illustrate in detail the composition of the present invention and the intended effect to be achieved. It should be noted that the accompanying drawings are simplified schematic drawings and, therefore, show only the components and combinations in relation to the present invention in order to provide a clearer description of the basic structure or method of implementation of the invention, while the actual components and layout may be more complex. In addition, for the sake of illustration, the components shown in each of the accompanying drawings of the present invention are not drawn in equal scale with the actual number, shape, and size of the implementation, and their detailed scale can be adjusted according to the needs of the design.

The directional terms mentioned in the following examples, such as: up, down, left, right, front or back, are only directions with reference to the additional drawings. Therefore, the directional terms used are for illustrative purposes and are not intended to limit the invention.

It should be noted that although the terms first, second, third . . . may be used to describe a variety of components, the components are not limited to the term. The term is only used to distinguish a single component from other components in the specification. Instead of using the same term in the request item, the first, second, third . . . may be substituted in the order in which the components are declared in the claims. Thus, in the following description, the first component may be the second component in the claims.

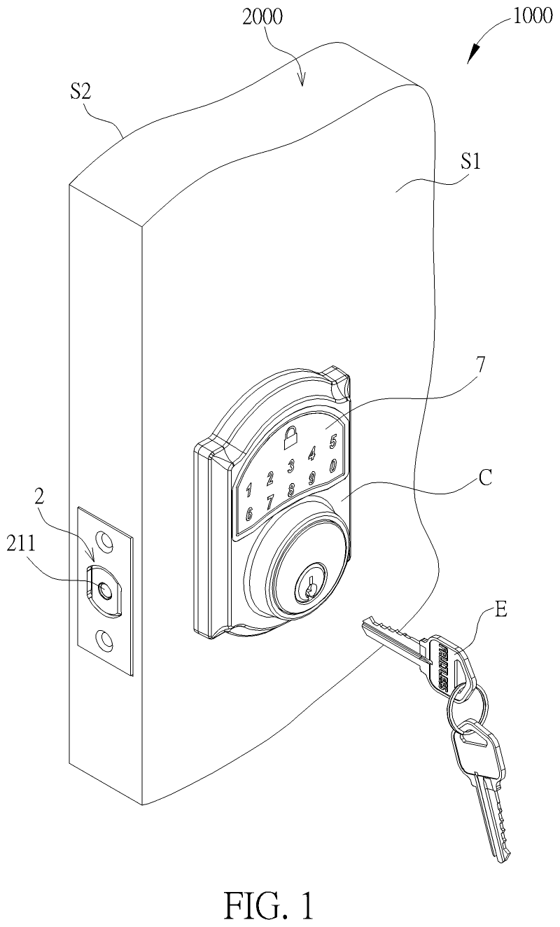

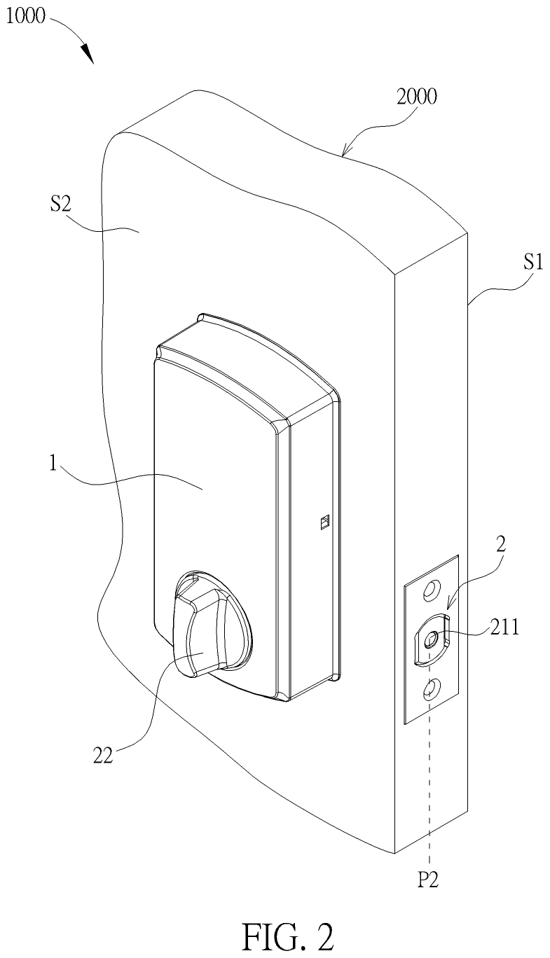

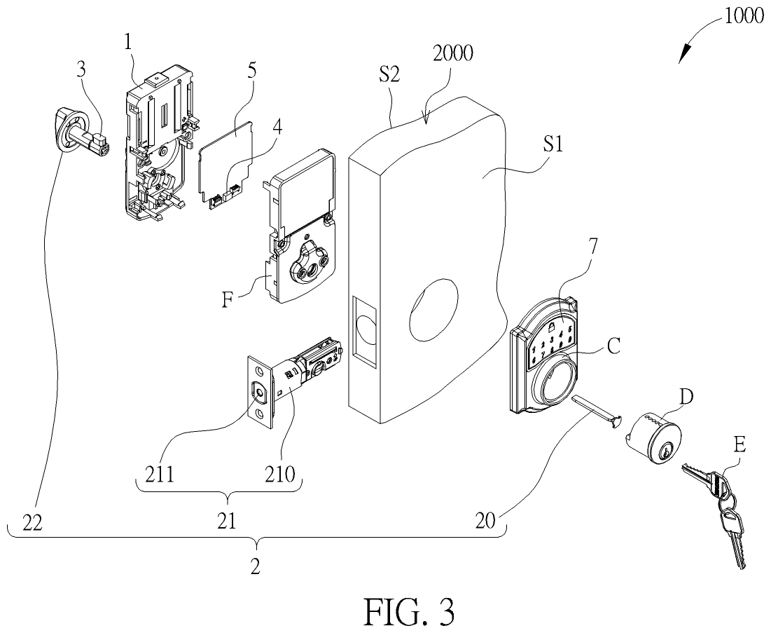

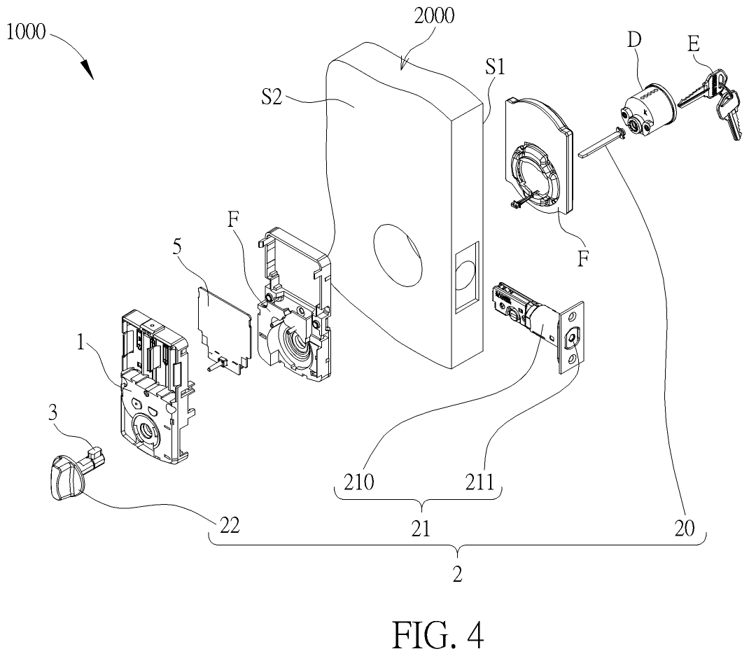

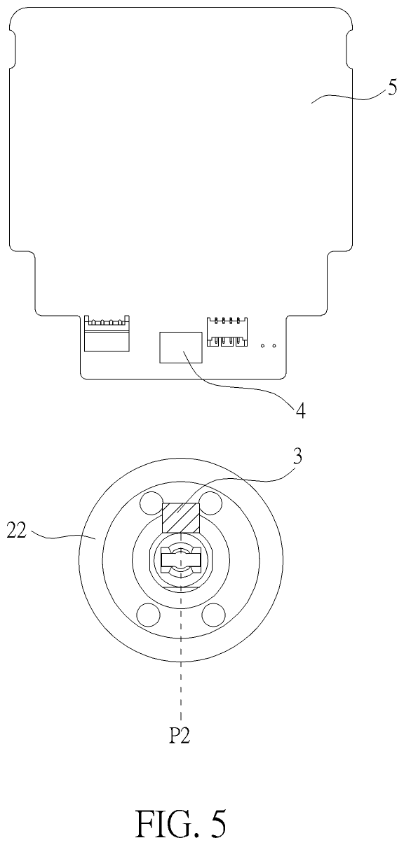

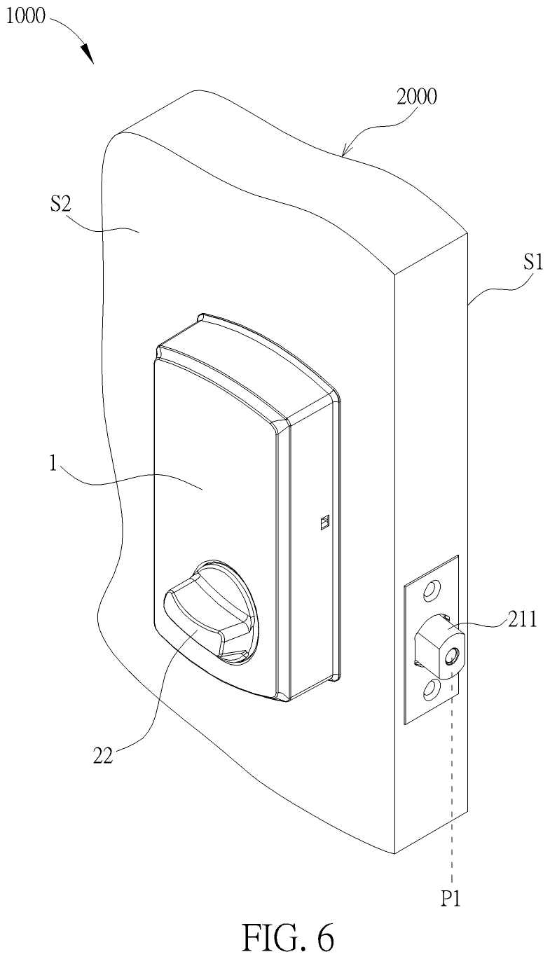

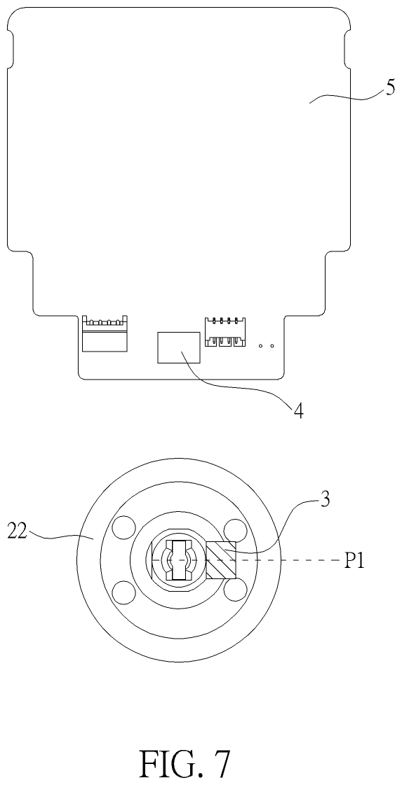

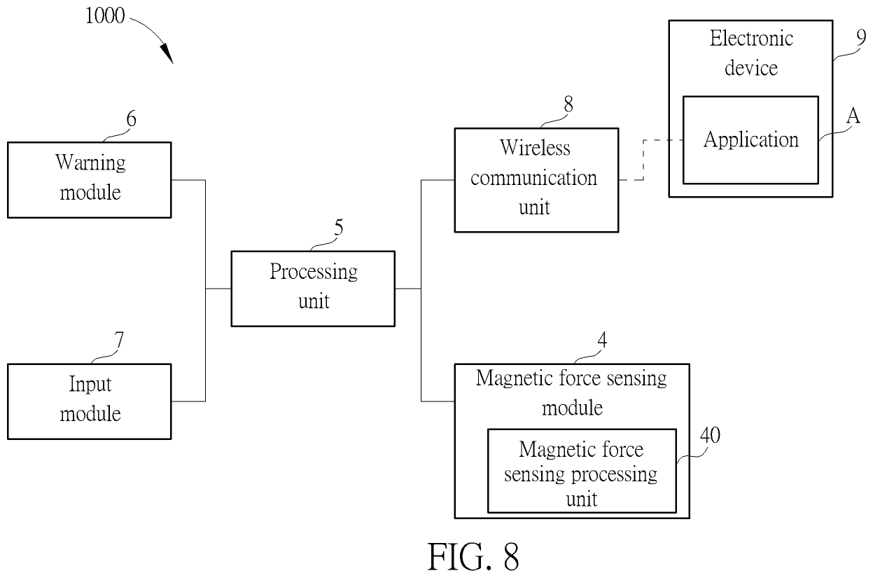

References are made to FIG. 1 to FIG. 8. FIG. 1 is a schematic view of a lock device 1000 according to an embodiment of the present invention. FIG. 2 is a schematic view of the lock device 1000 at an unlocking position P2 according to an embodiment of the present invention. FIG. 3 is a schematic exploded view of the lock device 1000 according to an embodiment of the present invention. FIG. 4 is a schematic exploded view of the lock device 1000 from another perspective according to an embodiment of the present invention. FIG. 5 is a schematic view of a knob member 22 and a magnetic member 3 at the unlocking position according to an embodiment of the present invention. FIG. 6 is a schematic view of the lock device 1000 at a locking position P1 according to an embodiment of the present invention. FIG. 7 is a schematic view of the knob member 22 and the magnetic member 3 at the locking position P1 according to an embodiment of the present invention. FIG. 8 is a functional block diagram of the lock device 1000 according to an embodiment of the present invention.

As shown in FIG. 1 to FIG. 8, the lock device 1000 is adapted to a door 2000 and includes a housing 1, a bolt mechanism 2, the magnetic member 3, and a magnetic sensing module 4. The housing 1 is disposed on a side of the door 2000, the bolt mechanism 2 is movably disposed on the housing 1, and the bolt mechanism 2 can be operated and moved between the locking position P1 (as shown in FIG. 6) and the unlocking position P2 (as shown in FIG. 2).

Specifically, the bolt mechanism 2 includes a transmission member 20, a deadbolt mechanism 21, and the knob member 22. The transmission member 20 is rotatably disposed on the housing 1, the deadbolt mechanism 21 includes a base 210 and a bolt member 211, the base 210 is connected to the transmission member 20, the bolt member 211 is movably disposed on the base 210, and the knob member 22 is connected to one end of the transmission member 20. The lock device 1000 further includes a shell C and a lock core mechanism D. The shell C is disposed on another side of the door 2000 opposite to the housing 1, and the shell C and the housing 1 may be, for example, arranged on an outer side 51 and an inner side S2 of the door 2000, respectively. For example, the inner side S2 of the door 2000 refers to a side located in a house (private space), while the outer side 51 of the door 2000 refers to another side located outside the house (public space).

The lock core mechanism D is disposed on the shell C and connected to one end of the transmission member 20. In practice, the lock core mechanism D may include a lock shell, a sleeve, an upper locking bead set, and a lower locking bead set. The sleeve is disposed inside the lock shell, the upper locking bead set is disposed inside the lock shell, the lower locking bead set is disposed inside the sleeve and against the upper locking bead set, and each lower locking bead of the lower locking bead set is at a different height position. When each lower locking bead of the lower locking bead set is abutted against the corresponding upper locking bead of the upper locking bead set, the lower locking beads of the lower locking bead set are at different height positions. When each lower locking bead of the lower locking bead set abuts against the corresponding upper locking bead of the upper locking bead set and a key E is not inserted into a keyhole on the sleeve, the upper locking beads of the upper locking bead set are held at different heights by the corresponding lower locking beads of the lower locking bead set, respectively. When the upper locking beads of the upper locking bead set are at different heights, one end of each of the upper locking beads of the upper locking bead set is located in the sleeve and another end of each of the upper locking beads of the upper locking bead set is located in the lock shell. In this way, each upper locking bead of the upper locking bead set locks the sleeve so that the sleeve cannot rotate relative to the lock shell. When the key E is inserted into the key hole on the sleeve, each locking tooth of the key E pushes against the corresponding lower locking bead of the lower locking bead set to drive each upper locking bead of the upper locking bead set, so that an end of each upper locking bead of the upper locking bead set moves to a junction of the lock shell and the sleeve. In this way, each upper locking bead of the upper locking bead set can be released from the sleeve, so that the sleeve can rotate relative to the lock shell.

Therefore, the lock core mechanism D can be operated to rotate after being unlocked by the key E. The lock core mechanism D is connected to the end of the transmission member 20, and when the lock core mechanism D is operated to rotate after being unlocked by the key E, the lock core mechanism D can drive the transmission member 20 to rotate. In addition, one end of the transmission member 20 is connected to the knob member 22, so that when the knob member 22 is operated (e.g., rotated) by a user, the knob member 22 can drive the transmission member 20 to rotate. In addition, the transmission member 20 is connected to the base 210 of the deadbolt mechanism 21 through the base 210, and when the transmission member 20 is driven to rotate, the transmission member 20 can drive the bolt member 211 of the deadbolt mechanism 21 to move between the locking position P1 (as shown in the FIG. 6) and the unlocking position P2 (as shown in the FIG. 2).

Furthermore, the magnetic member 3 is movable with the bolt mechanism 2, and the magnetic sensing module 4 is disposed inside the housing 1 and configured to sense magnetic force generated by the magnetic member 3. The lock device 1000 can further include a processing unit 5. In this embodiment, the magnetic sensing module 4 can be a three-axis magnetic sensor, and the processing unit 5 can be a circuit board. The magnetic sensing module 4 is disposed on the circuit board and coupled to the processing unit 5. The magnetic sensing module 4 can further include a magnetic sensing processing unit 40.

The magnetic member 3 is disposed on the lock device 1000 and located on the door 2000. In this embodiment, the magnetic member 3 is affixed on a drive lever of the knob member 22 and moves with the bolt mechanism 2, but the invention is not limited thereto. For example, the magnetic member 3 can also be disposed on the transmission member 20 or the bolt member 211 of the bolt mechanism 2 and movable with the bolt mechanism 2. When the bolt mechanism 2 moves to the unlocking position P2 as shown in FIG. 2, the magnetic member 3 is also driven by the bolt mechanism 2 to the unlocking position P2 as shown in FIG. 5, and the magnetic member 3 is moved relatively close to the magnetic sensing module 4. When the bolt mechanism 2 moves to the locking position P1 as shown in FIG. 6, the magnetic member 3 is also driven by the bolt mechanism 2 to the locking position P1 as shown in FIG. 7, and the magnetic member 3 is moved relatively away from the magnetic sensing module 4.

Therefore, during a movement of the bolt mechanism 2 between the locking position P1 and the unlocking position P2, the magnetic member 3 is driven by the bolt mechanism 2 to move away from or close to the magnetic sensing module 4, so that the magnetic sensing module 4 can sense a magnetic force variation generated by the magnetic member 3 relative to the magnetic sensing module 4 during a process of moving away from or close to the magnetic sensing module 4 as a mechanism to determine the position of the bolt mechanism 2.

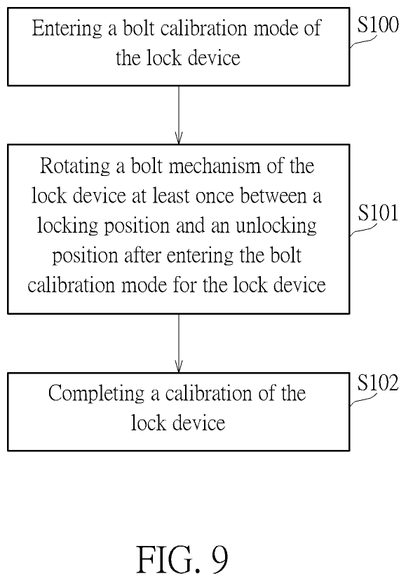

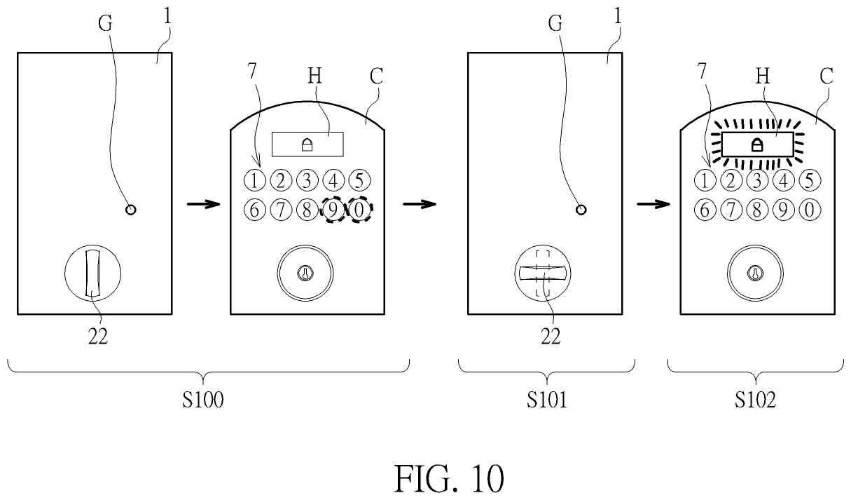

Referring to FIG. 8 to FIG. 10, FIG. 9 is a flowchart of a bolt calibration method according to an embodiment of the present invention, and FIG. 10 is a schematic view illustrating a bolt calibration method according to an implementation corresponding to the flowchart in FIG. 9. The lock device 1000 further includes an input module 7 coupled to the processing unit 5, the input module 7 is configured for a user to enter a password, and the processing unit 5 is stored with a preset code. When the password (e.g., entered by the user) matches the preset code stored in the processing unit 5, the processing unit 5 enters a bolt calibration mode.

In this embodiment, the input module 7 can be a set of physical buttons, and the password is in a specific sequence of operating (e.g., pressing) the physical buttons. The bolt calibration method includes the following steps:

Step S100: entering the bolt calibration mode of the lock device 1000;

Step S101: rotating the bolt mechanism 2 of the lock device 1000 at least once between the locking position P1 and the unlocking position P2 after entering the bolt calibration mode of the lock device 1000; and

Step S102: completing a calibration of the lock device 1000.

The lock device 1000 has a mode button G. As shown in FIG. 10, when it is desired to enter the bolt calibration mode of the lock device 1000, the mode button G can be pressed firstly to enter a setting mode, and after entering the setting mode, the “key number 9” and “key number 0” of the set of physical buttons can be pressed to enter the bolt calibration mode of the lock device 1000 (step S100). In other words, the sequence of pressing “key number 9” and “key number 0” can be a specific sequence for entering the bolt calibration mode of this embodiment, but the invention is not limited thereto. The specific sequence can also be an arrangement of the key numbers of the set of physical buttons, according to actual requirements.

After entering the bolt calibration mode of the lock device 1000, the bolt mechanism 2 of the lock device 1000 is moved at least once between the locking position P1 and the unlocking position P2 (step S101). As described above, when the bolt mechanism 2 is moved to the locking position P1, the magnetic member 3 is most distant from the magnetic sensing module 4, and the magnetic force of the magnetic member 3 is then sensed by the magnetic sensing module 4 as a first magnetic force value T1; when the bolt mechanism 2 is moved to the unlocking position P2, the magnetic member 3 is closest to the magnetic sensing module 4, and the magnetic force of the magnetic member 3 is then sensed by the magnetic sensing module 4 as a second magnetic force value T2.

For example, the bolt mechanism 2 of the lock device 1000 is moved between the locking position P1 and the unlocking position P2 for N times, wherein N is a positive integer, and N first magnetic values (T1, i) and N second magnetic values (T2, i) are generated during a period, wherein i is a positive integer from 1 to N. In this way, the N first magnetic values (T1, i) can be used to derive a first magnetic interruption threshold interval Tr1 for determining whether the bolt mechanism 2 is in the locking position P1, and the N second magnetic values (T2, i) can be used to derive a second magnetic interruption threshold interval Tr2 for determining whether the bolt mechanism 2 is in the unlocking position P2.

For example, when N first magnetic values (T1, i) and N second magnetic values (T2, i) are generated, the N first magnetic values (T1, i) and the first magnetic interruption threshold interval Tr1 can be exemplified as satisfying the relationship of Equation 1, and the N second magnetic values (T2, i) and the second magnetic interruption threshold interval Tr2 can be exemplified as satisfying the relationship of Equation 2:

Min(T1,i)≤Tr1≤Max(T1,i),i=1˜N (Equation 1)

Min(T2,i)≤Tr2≤Max(T2,i),i=1˜N (Equation 2)

In other words, the first magnetic interruption threshold interval Tr1 can be between the maximum of the N first magnetic values (T1, i) and the minimum of the N first magnetic values (T1, i), and the second magnetic interruption threshold interval Tr2 can be between the maximum of the N second magnetic values (T2, i) and the minimum of the N second magnetic values (T2, i). It is worth mentioning that Equation 1 is an example of the present invention, and the relationship between the N first magnetic force values (T1, i) and the first magnetic interruption threshold interval Tr1 can be defined according to actual requirements. Similarly, Equation 2 is an example of the present invention, the relationship between the N second magnetic force values (T2, i) and the second magnetic interruption threshold interval Tr2 can be defined according to actual requirements.

In this way, the processing unit 5 can calculate the first magnetic interrupt valve interval Tr1 and the second magnetic interrupt valve interval Tr2 during the movement of the bolt mechanism 2 between the locking position P1 and the unlocking position P2. Further, the processing unit 5 can store the first magnetic interrupt valve interval Tr1 as a preset locking interval value and store the second magnetic interrupt valve interval Tr2 as a preset unlocking interval value, so as to complete the calibration of the lock device 1000 with respect to the bolt mechanism 2 (step S102). As shown in FIG. 10, after the calibration of the lock device 1000 with respect to the bolt mechanism 2 is completed, the processing unit 5 can control a light-emitting unit H to emit light, so as to inform the user that the lock device 1000 has completed the calibration with respect to the bolt mechanism 2.

Therefore, when a magnitude of the magnetic force sensed by the magnetic sensing module 4 is within the preset locking interval value (i.e., the first magnetic interruption threshold interval Tr1), it can be determined that the lock device 1000 is in the locking position P1; when the magnitude of the magnetic force sensed by the magnetic sensing module 4 is within the preset unlocking interval value (i.e., the second magnetic interruption threshold interval Tr2), it can be determined that the lock device 1000 is in the unlocking position P2.

In this embodiment, the magnetic sensing module 4 can include the magnetic sensing processing unit 40 (as shown in FIG. 8), which is used to determine whether the magnetic force sensed by the magnetic sensing module 4 is within the afore-mentioned preset locking interval value or within the preset unlocking interval value, and the present invention is not limited thereto. For example, the processing unit 5 can also be used in the present invention to determine whether the magnetic force sensed by the magnetic sensing module 4 is within the afore-mentioned preset locking interval value or within the preset unlocking interval value, according to actual requirements.

The following is an example of the processing unit 5 determining whether the magnetic force sensed by the magnetic sensing module 4 is within the preset locking interval value or within the preset unlocking interval value. When the processing unit 5 receives the magnetic force from the magnetic sensing module 4 within the preset locking interval value (i.e., the first magnetic interrupt valve value interval Tr1) or within the preset unlocking interval value (i.e., the second magnetic interrupt valve value interval Tr2), the processing unit 5 generates a magnetic event interrupt signal to indicate that the lock device 1000 is in the locking position P1 or the unlocking position P2. Furthermore, after completing the bolt calibration method, when the user operates the bolt mechanism 2 through the key E or other manners, a magnetic force is generated as a determination of a position of the bolt member 211, and the technical means of the magnetic event interrupt signal being generated when the magnitude of the magnetic force being within the preset locking interval value (i.e., the first magnetic interruption threshold interval Tr1) or within the preset unlocking interval value (i.e., the second magnetic interruption threshold interval Tr2) is a preferred embodiment to achieve power saving, but the present invention is not limited thereto. For example, in other embodiments, determining whether the magnetic event interrupt signal is generated or not can also be set that when the magnetic force received by the processing unit 5 is not within the preset locking interval value or not within the preset unlocking interval value, a magnetic event interrupt signal (corresponding to a redefined equation) can be generated for the lock device 1000 to perform an action.

In this embodiment, the processing unit 5 can be used to generate the magnetic event interrupt signal, but the present invention is not limited thereto. For example, the magnetic sensing processing unit 40 of the magnetic sensing module 4 can also be used to generate the magnetic event interrupt signal, according to actual requirements.

In this embodiment, the lock device 1000 can further include a warning module 6 coupled to the processing unit 5, and the warning module 6 can be a buzzer. When the magnetic force received by the processing unit 5 from the magnetic sensing module 4 is not within the preset locking interval value (i.e., the first magnetic interruption threshold interval Tr1) and not within the preset unlocking interval value (i.e., the second magnetic interruption threshold interval Tr2), in one embodiment, the processing unit 5 controls the warning module 6 (i.e., the buzzer) to generate a warning signal (e.g., a warning tone). In another embodiment, the magnetic sensing processing unit 40 of the magnetic sensing module 4 controls the warning module 6 (i.e., the buzzer) to generate a warning signal (e.g., a warning tone), so as to notify the user that the lock device 1000 is not in the locking position P1 nor in the unlocking position P2. That is to say, the lock device 1000 can generate the warning signal (e.g., the warning tone) to notify the user to make a check of whether a bolt is bolted or not, and the processing unit 5 can also control the lock device 1000 to enter a sleep mode to save power consumption of a battery.

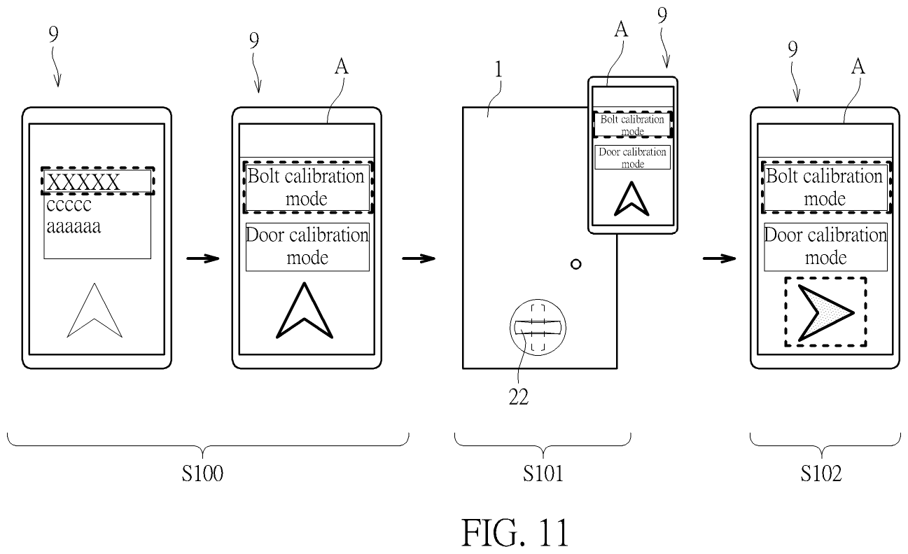

References are made to FIG. 8 and FIG. 11. FIG. 11 is another schematic view illustrating a bolt calibration method according to another implementation corresponding to the flowchart in FIG. 9. The difference between the implementation in FIG. 11 and that in FIG. 9 is that an electronic device 9 is used to enter the bolt calibration mode in Step S100 in this implementation. Specifically, the lock device 1000 further includes a wireless communication unit 8 coupled to the processing unit 5, and the wireless communication unit 8 is signally connected to the electronic device 9 so that the electronic device 9 can enter the bolt calibration mode by controlling the processing unit 5 through an application A.

In this embodiment, the wireless communication unit 8 can be a Bluetooth® communication unit, the electronic device 9 can be a smartphone, and the application A can include a user interface (UI), a firmware for communication between hardware components, a database, or a combination thereof.

As shown in FIG. 11, when it is desired to enter the bolt calibration mode of the lock device 1000, communication between the lock device 1000 and the electronic device 9 can be established. After establishing the communication between the electronic device 9 and the lock device 1000, the bolt calibration mode is entered through the user interface of the application A installed in the electronic device 9 (e.g., by clicking on a button icon of the user interface of the application A). For example, if the knob is rotated to the right, an arrow image can be rotated to the right and an angle value of the rotation can be displayed accordingly, but is not limited to the arrow image. As for the step S101 and step S102 of this implementation, they are the same as the previous implementation, and for the sake of brevity, are not repeated herein.

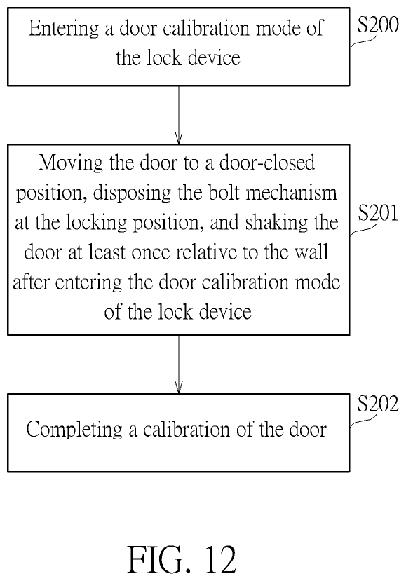

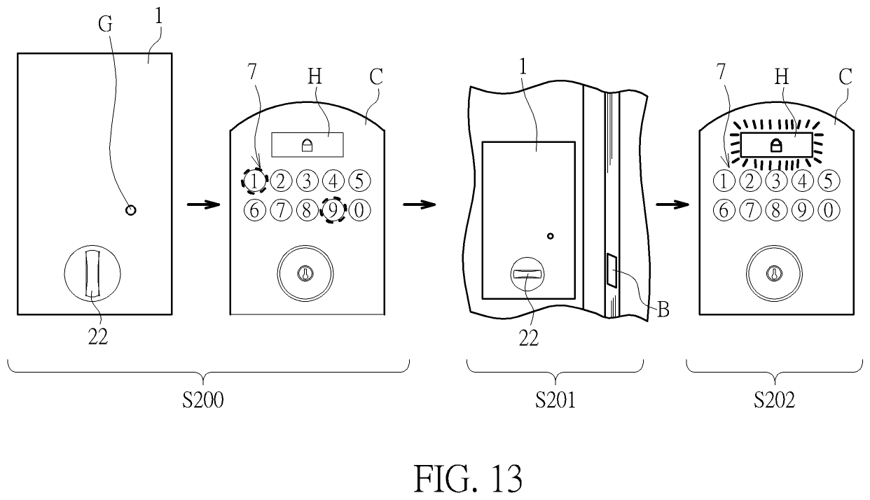

Referring to FIG. 12 and FIG. 13, FIG. 12 is a flowchart of a door calibration method according to an embodiment of the present invention, and FIG. 13 is a schematic view illustrating a door calibration method according to an implementation corresponding to the flowchart in FIG. 12. The door 2000 can be moved toward a door-closed position or away from the door-closed position relative to a wall. “The door-closed position” indicates that the door 2000 is relatively close to the wall and to a position that allows the bolt mechanism 2 to smoothly reach the locking position P1, and “away from the door-closed position” indicates that the door 2000 is moved away from the door-closed position. Furthermore, when performing a calibration of the door, the door 2000 is first moved to the door-closed position. The bolt mechanism 2 is disposed at the locking position P1, and then the door 2000 is shaken relative to the wall.

The lock device 1000 can further include a magnetic force generating member B, which is disposed on the wall. The door calibration method includes the following steps:

Step S200: entering a door calibration mode of the lock device 1000;

Step S201: moving the door 2000 to a door-closed position, disposing the bolt mechanism 2 at the locking position P1, and shaking the door 2000 at least once relative to the wall after entering the door calibration mode of the lock device 1000; and

Step S202: completing a calibration of the door 2000.

When it is desired to enter the door calibration mode of the lock device 1000, the mode button G can be pressed firstly to enter a setting mode. After entering the setting mode, the “key number 1” and “key number 9” of the set of physical buttons are pressed to enter the door calibration mode of the lock device 1000 (step S200). In other words, a sequence of pressing “key number 1” and “key number 9” can be the specific sequence for entering the door calibration mode of this embodiment, but the invention is not limited thereto. The specific sequence can also be an arrangement of the key numbers on the group of physical buttons, according to actual requirements. In addition, in step S200, when it is desired to enter the door calibration mode of the lock device 1000, the communication between the electronic device 9 and the lock device 1000 also can be established, such as establishing a communication between the lock device 1000 and the electronic device 9 through the user interface of the application A installed in the electronic device 9 (e.g., by clicking on a button icon of the user interface of the application A) to enter the door calibration mode. In addition, when the door calibration mode is completed, the user interface can display a status column corresponding to a position of the door. For example, the status column of the opening door is “open” and the status column of the closed door is “closed”, and a displacement value of the door 2000 can also be displayed. For the sake of brevity, detailed figures and descriptions are omitted.

After entering the calibration mode of the lock device 1000, the door 2000 is moved to the door-closed position and the bolt mechanism 2 is disposed at the locking position P1, and then the door 2000 is shaken relative to the wall at least once (step S201). During the process of shaking the door 2000 relative to the wall, the magnetic sensing module 4 moves close to and away from a magnetic force generating member B located on the wall with the door 2000. Therefore, the magnetic sensing module 4 can sense at least one magnetic force variation generated by the magnetic force generating member B during a shaking process of the door 2000 relative to the wall, and the processing unit 5 can determine a door threshold interval X according to the at least one magnetic force variation and a range of the magnetic force variation sensed by the magnetic sensing module 4 when the door is in the door-closed position.

For example, take that the door is in the door-closed position 2000 and the bolt mechanism 2 is in the locking position P1, and the door is shaken for M times as an example, wherein M is a positive integer, and M magnetic values (W, j) are generated during a period, wherein j is a positive integer from 1 to M. In this way, M magnetic values are generated. In this way, the M magnetic values (W, j) can be used to derive the door threshold interval X for determining whether the door 2000 is in the door-closed position.

For example, after generating M magnetic values (W, j), the M magnetic values (W, j) and the door threshold interval X can be exemplified as satisfying the relationship in Equation 3:

Min(W,j)≤X≤Max(W,j),j=1˜M (Equation 3)

In other words, the door threshold interval X can be between the maximum of the M magnetic values (W, j) and the minimum of the M magnetic values (W, j). It is worth mentioning that, Equation 3 is an example of the present invention, the relationship between the M magnetic force values (W, j) and the door threshold interval X can be defined according to actual requirements.

In this way, the processing unit 5 can calculate the door threshold interval X during the process of the door 2000 close to and away from the door-closed position. Furthermore, the processing unit 5 can store the door threshold interval X as a preset door interval value to complete the calibration of the lock device 1000 to the door 2000 (step S202). As shown in FIG. 13, when the calibration of the lock device 1000 to the door 2000 is completed, the processing unit 5 may control the light-emitting unit H to notify the user that the lock device 1000 has completed the calibration of the door 2000.

In practice, when the processing unit 5 or the magnetic sensing processing unit 40 receives the magnetic force from the magnetic sensing module 4 within the preset door interval value (i.e., the door threshold interval X), the processing unit 5 determines that the door 2000 is in the door-closed position. When the processing unit 5 or the magnetic sensing processing unit 40 receives the magnetic force from the magnetic sensing module 4 not within the preset door interval value (i.e., the door threshold interval X), the processing unit 5 determines that the door 2000 is in an abnormal state and further generates a door unclosed warning signal. For example, when the magnetic force from the magnetic sensing module 4 is not within the preset door interval value (i.e., the door threshold interval X), the door unclosed warning signal can be generated by the processing unit 5 to control the warning module 6 (i.e., the buzzer) to generate the warning signal (e.g., the warning tone) to notify the user that the door 2000 is not at the door-closed position, i.e., the lock device 1000 can generate the warning signal (e.g., the warning tone) to notify the user of making a check of whether the door 2000 is closed or not.

Compared with the prior art, the lock device of the present invention include a housing, a bolt mechanism, a magnetic member, and a magnetic sensing module. The magnetic member is movable with the bolt mechanism, and the magnetic sensing module senses the magnetic force generated by the magnetic member during the movement of the bolt mechanism between the locking position and the unlocking position. The lock device of the present invention further includes a magnetic force generating member, and the magnetic force generating member is disposed on the wall. The magnetic sensing module senses the magnetic force variation generated by the magnetic force generating member during the process of moving the bolt mechanism to the locking position and shaking the door relative to the wall when the door is moved to the door-closed position. In this way, the lock device of the invention requires only a single magnetic sensing module to sense the magnetic force generated by the magnetic member moving with the bolt mechanism to determine the position of the bolt, and to sense the magnetic generating member disposed on the wall to determine the position of the door.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lock device adapted to a door, the lock device comprising:
a housing disposed on a side of the door;
a bolt mechanism movably disposed on the housing, the bolt mechanism being operable to move between a locking position and an unlocking position;
a magnetic member movable with the bolt mechanism; and
a magnetic sensing module disposed inside the housing, and the magnetic sensing module sensing a magnetic force generated by the magnetic member during a movement of the bolt mechanism between the locking position and the unlocking position.

2. The lock device of claim 1, further comprising:
a processing unit for sensing at least one magnetic force variation generated by the magnetic member during at least one movement of the bolt mechanism between the locking position and the unlocking position and further for determining a magnetic interruption threshold interval according to the at least one magnetic force variation when the processing unit is at a bolt calibration mode.

3. The lock device of claim 2, wherein the magnetic sensing module comprises a magnetic sensing processing unit, the processing unit or the magnetic sensing processing unit generates a magnetic event interrupt signal when the magnetic sensing module senses that the magnetic force generated by the magnetic member is within the magnetic interruption threshold interval, and when the magnetic event interrupt signal is generated by the processing unit, the bolt mechanism is located at one of the locking position and the unlocking position.

4. The lock device of claim 2, further comprising:
a warning module coupled to the processing unit for generating a warning signal.

5. The lock device of claim 2, further comprising:
an input module coupled to the processing unit for a user to enter a password, wherein a preset code is stored in the processing unit, and when the password matches the preset code stored in the processing unit, the processing unit enters the bolt calibration mode.

6. The lock device of claim 2, further comprising:
a wireless communication unit coupled to the processing unit, the wireless communication unit being signally connected to an electronic device, and the electronic device controlling the processing unit to enter the bolt calibration mode by an application.

7. The lock device of claim 1, wherein the door is movable toward a door-closed position or away from the door-closed position relative to a wall, and the lock device further comprises:
a magnetic force generating member disposed on the wall; and
a processing unit coupled to the magnetic sensing module;
wherein the magnetic sensing module senses the magnetic force generated by the magnetic force generating member during a process of the door moving away from the door-closed position;
wherein the processing unit generates a signal indicating that the door is not fully closed when the magnetic force generated by the magnetic force generating member and sensed by the magnetic sensing module is not within a door threshold interval.

8. The lock device of claim 1, wherein the magnetic member is disposed on the lock device and located on the door.

9. A lock device adapted to a door, the door being movable toward a door-closed position or away from the door-closed position relative to a wall, the lock device comprising:
a housing disposed on a side of the door;
a bolt mechanism movably disposed on the housing;
a magnetic force generating member disposed on the wall;
a magnetic sensing module disposed inside the housing, when the door is located at the door-closed position and shakes relative to the wall, the magnetic sensing module sensing a magnetic force generated by the magnetic force generating member; and
a processing unit for sensing at least one magnetic force variation generated by the magnetic force generating member during a process of at least one shake of the door relative to the wall when the door is located at the door-closed position and the bolt mechanism is located at a locking position and further for determining a door threshold interval according to the at least one magnetic force variation, when the processing unit enters a door calibration mode.

10. The lock device of claim 9, wherein the magnetic sensing module comprises a magnetic sensing processing unit, when the magnetic sensing module senses that the magnetic force generated by the magnetic force generating member is not within the door threshold interval, the processing unit or the magnetic sensing processing unit generates a door unclosed warning signal.

11. The lock device of claim 9, further comprising:
an input module coupled to the processing unit for a user to enter a password, wherein a predetermined code is stored in the processing unit, and when the password matches the predetermined code stored in the processing unit, the processing unit entering the door calibration mode.

12. The lock device of claim 9, further comprising:
a wireless communication unit coupled to the processing unit, the wireless communication unit being signally connected to an electronic device, and the electronic device controlling the processing unit to enter the bolt calibration mode by an application.

13. The lock device of claim 9, wherein the bolt mechanism comprises:
a transmission member rotatably disposed on the housing; and
a deadbolt mechanism, comprising:
a base connected to the transmission member; and
a bolt member movably disposed on the base;
wherein the transmission member is rotated to drive the bolt member to move between the locking position and the unlocking position through the base.

14. The lock device of claim 13, wherein the bolt mechanism further comprises:
a knob member connected to one end of the transmission member, and the knob member being operated rotate the transmission member.

15. The lock device of claim 13, further comprising:
a shell disposed on another side of the door opposite to the housing; and
a lock core mechanism disposed on the shell and connected to one end of the transmission member, and the lock core mechanism is operated to rotate the transmission member after being unlocked by a key.

16. A bolt calibration method adapted to a lock device, the method comprising:
entering a bolt calibration mode of the lock device;
rotating a bolt mechanism of the lock device at least once between a locking position and an unlocking position after entering the bolt calibration mode for the lock device; and
completing a calibration of the lock device.

17. The bolt calibration method of claim 16, wherein rotating the bolt mechanism of the lock device at least once between the locking position and the unlocking position comprises:
moving the bolt mechanism movable with a magnetic member, disposing a magnetic sensing module inside a shell of the lock device, and the magnetic sensing module sensing at least one magnetic force variation generated by the magnetic member; and
determining a magnetic interruption threshold interval according to the at least one magnetic force variation.

18. The bolt calibration method of claim 17, wherein when the magnetic sensing module senses that a magnetic force generated by the magnetic member is within the magnetic interruption threshold interval, a processing unit of the lock device or a magnetic sensing processing unit of the magnetic sensing module generates a magnetic event interrupt signal, and when the magnetic event interrupt signal is generated by the processing unit of the lock device or the magnetic sensing processing unit of the magnetic sensing module, the bolt mechanism is located at one of the locking position and the unlocking position.

19. The bolt calibration method of claim 16, wherein entering a bolt calibration mode of the lock device comprises:
operating an input module to enter a setting mode; and
operating the input module in a certain order after entering the setting mode to enter the bolt calibration mode.

20. The bolt calibration method of claim 16, wherein entering a bolt calibration mode of the lock device comprises:
establishing a communication with the lock device through an electronic device; and
entering the bolt calibration mode through a user interface of an application installed in the electronic device after establishing the communication between the lock device and the electronic device.

21. The bolt calibration method of claim 16, wherein completing the calibration of the lock device comprises:
a processing unit of the lock device controlling a light-emitting unit to emit light.

22. A door calibration method adapted to a lock device, the lock device being disposed on a door that moves toward a door-closed position or away from the door-closed position relative to a wall, wherein the lock device is capable of calibrating a position of the door, the door calibration method comprising:
entering a door calibration mode of the lock device;
moving the door to a door-closed position, locking the door, and shaking the door at least once after entering the door calibration mode of the lock device; and
completing a calibration of the door.

23. The door calibration method of claim 22, wherein moving the door to a door-closed position, locking the door, and shaking the door at least once after entering the door calibration mode of the lock device comprises:
disposing a magnetic force generating member on the wall, installing a magnetic sensing module inside a shell of the lock device, and the magnetic sensing module sensing at least one magnetic force variation generated by the magnetic force generating member; and
determining a door threshold interval according to the at least one magnetic force variation.

24. The door calibration method of claim 23, wherein when the magnetic sensing module senses that a magnetic force generated by the magnetic force generating member is not within the door threshold interval, a processing unit of the lock device or the magnetic sensing processing unit generates a door unclosed warning signal.

25. The door calibration method of claim 22, wherein entering a door calibration mode of the lock device comprises:
operating an input module to enter a setting mode; and
operating the input module in a certain order after entering the setting mode to enter the door calibration mode.

26. The door calibration method of claim 22, wherein entering a door calibration mode of the lock device comprises:
establishing a communication with the lock device through an electronic device;
entering the door calibration mode through a user interface of an application installed in the electronic device after establishing the communication between the lock device and the electronic device.
